(19) United States
(12) Patent Application Publication
(10) Pub. No.: US 2012/0173439 A1
(43) Pub. Date: Jul. 5, 2012

(54) MANAGING A BREACH OF CONTRACT

(76) Inventor: Alfred Ronnie Levy, Brooklyn, NY (US)

(21) Appl. No.: 13/343,419

(22) Filed: Jan. 4, 2012

Related U.S. Application Data
(60) Provisional application No. 61/429,602, filed on Jan. 4, 2011.

(51) Int. Cl. G06Q 50/16; G06Q 50/18

(52) U.S. Cl. 705/307

(57) ABSTRACT

A computer system includes servers which connect to user workstations using a network, where landlords and attorneys may meet use user workstations to communicate with each other and the system in real time, with respect to actions for eviction. The system provides a workflow which prompts landlords and attorneys with respect to decision points in the processing of the action for eviction, and assists the landlord and attorneys with data collection, form entry, document production, official filings, and other steps necessary in order to move through the decision tree and successfully carry out the action.

### CROSS REFERENCE TO RELATED APPLICATIONS

This application claims the benefit of related U.S. Provisional Patent Application No. 61/429,602, filed Jan. 4, 2011, the contents of which are incorporated herein by reference.

### FIELD OF THE INVENTION

The disclosure relates to a server based system for expediting processing of an action for breach of contract, and more particularly an action for eviction by landlords and attorneys.

### BACKGROUND OF THE INVENTION

Real or personal property is provided to users of the property in exchange for regular payments. An example is tool rental, or a tenancy in real property. Users, such as tenants, frequently are unable or unwilling to make all payments, or to make all payments in a timely manner. An action for such breach includes the owner exercising legal rights, which may include the use of a tribunal, to carry out a remedy for the breach. For example, a landlord may make demands for payment, deny access to the property, and use the judicial system to obtain an order, which may ultimately enable the landlord to evict the tenant, should the tenant continue to refuse to make payment.

### SUMMARY OF THE INVENTION

The disclosure provides a method for facilitating corrective action by an owner with respect to a user of the owner's property who is in breach of an agreement with the owner, and comprises using at least one computer server to receive, into storage connectable to the at least one computer server, information pertaining to the owner, the property, and the user; receive, into storage connectable to the at least one computer server, documents and information, including date information, pertaining to a tribunal that has jurisdiction with respect to the breach; receive, into storage connectable to the at least one computer server, messages between the owner and one or more service providers practicing before the tribunal; communicate in real time, using the at least one server, the information received into storage, with the owner, and the one or more service providers; and calculate a workflow, including a sequence of actions to be carried out, the sequence of actions based upon information with respect to the owner, the property, the user, and the tribunal, the workflow operative to guide the owner or the one or more service providers with respect to actions which address the breach for the benefit of the owner.

In further embodiments of the disclosure, the method further includes communicating in real time the information received into storage, with an administrator of the method and the at least one computer server; the one or more server creates a log of communication among the owner and one or more service providers; the one or more server prompts the owner or the one or more service providers to prepare a complaint, file the complaint with a court, record a receipt of complaint from the court, record information from the court pertaining to the complaint, and communicate information from the court to the owner and the one or more service provider; and the one or more server further prompts the owner or the one or more service providers to track a disposition of the court, and to track payments from a user if the court so orders.

In other embodiments, the breach relates to a lease, the owner is a landlord, and the user is a tenant; the breach relates to a lease, and the corrective action is an eviction of the user, who is a tenant; the service provider is a legal service provider or attorney; and documents are received into storage connectable to the at least one computer server are scanned.

In another embodiment of the disclosure, an action for eviction by a landlord with respect to a tenant who is in breach of a lease with the landlord, comprises using at least one computer server to receive, into storage connectable to the at least one computer server, information pertaining to the landlord, the real property, and the tenant; receive, into storage connectable to the at least one computer server, documents and information, including date information, pertaining to a tribunal that has jurisdiction with respect to landlord tenant actions; receive, into storage connectable to the at least one computer server, messages between the owner and one or more attorneys practicing before the tribunal; communicate in real time, using the at least one server, the information received into storage, with the landlord, and the one or more attorneys; and calculate a workflow, including a sequence of actions to be carried out, the sequence of actions based upon information with respect to the landlord, the real property, the tenant, and the tribunal, the workflow operative to guide the owner or the one or more attorneys with respect to actions which address the breach for the benefit of the landlord.

In yet further embodiments, the method further includes communicating in real time the information received into storage, with an administrator of the method and the at least one computer server; the one or more server creates a log of communication among the landlord and one or more attorneys; the one or more server prompts the landlord or the one or more attorneys to prepare a complaint, file the complaint with a court, record a receipt of complaint from the court, record information from the court pertaining to the complaint, and communicate information from the court to the landlord and the one or more attorney.

In other embodiments of the disclosure, the one or more server further prompts the landlord or the one or more attorneys to track a disposition of the court, and to track payments from a tenant if the court so orders; and documents are received into storage connectable to the at least one computer server are scanned.

In another embodiment of the disclosure, a method for facilitating an action for eviction by a landlord with respect to a tenant who is in breach of a lease with the landlord, comprising using at least one computer server to receive, into storage connectable to the at least one computer server, information pertaining to the landlord, the real property, and the tenant; receive, into storage connectable to the at least one computer server, documents and information, including date information, pertaining to a tribunal that has jurisdiction with respect to landlord tenant actions, including information pertaining to case assignments, court appearances, court calendar, and court orders; receive, into storage connectable to the at least one computer server, messages between the owner and one or more attorneys practicing before the tribunal; communicate in real time, using the at least one server, the information received into storage, with the landlord, and the one or more attorneys; and calculate a workflow, including a sequence of actions to be carried out, the sequence of actions based upon information with respect to the landlord, the real property, the tenant, and the tribunal, the workflow operative to guide the owner or the one or more attorneys with respect to actions which address the breach for the benefit of the landlord, and including the information received into storage connectable to the at least one computer server, communications to the tenant, communications to the court, tracking responses from the tenant, and tracking responses from the court.

In yet further embodiments of the disclosure, a method further includes using the at least one computer server for presenting a series of questions, generated by software executing upon the at least one computer server, to at least one of the owner, service provider, and user, the questions related to a specific task relating to the breach; and analyzing responses to at least one of the series of questions, and determining subsequent questions based upon the analyzed responses, the owner, service provider, or user thereby guided to produce information needed to accomplish the task.

In embodiments thereof, the series of questions include a question relating to an event selected from the group consisting of whether or not: the breach relates to a residential or commercial lease, the user appeared before the tribunal, the user cured the breach, a stipulation was agreed to, and the case was heard by the tribunal.

Alternatively, the series of questions include a question relating to an event selected from the group consisting of whether or not: the tribunal rescheduled a hearing, the tribunal announced a new hearing date, the tribunal was adjourned, the court issued a judgment, the court issued a judgment for possession, and the court issued a warrant.

An another alternative, the series of questions include a question relating to an event selected from the group consisting of: contract information, complaint information, and a desired legal course of direction; and further includes creating at least one task operative to further the desired legal course of direction. In an embodiment, the series of questions are related to creating one or more documents useable for filing a new case with the tribunal.

In further embodiments, the at least one computer server is used for storing information pertaining to prior corrective actions of an owner, and the current status of at least one of the prior corrective actions; and presenting, upon request of the owner, a detailed list of the stored information. Alternatively, storing information with respect to one or more corrective actions, the information including communications, the calculated workflow, documents relating to the workflow, and a status of the corrective actions; organizing the stored information in a sequentially ordered format; and presenting a detailed report of the organized information. In a yet further embodiment, the at least one computer server is used to determine possible upcoming events or tasks relating to the one or more corrective actions, and to add the possible upcoming events or tasks to the organized information.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIGS. 1A-1B are a block diagram of the interaction and relationship between people, places and things of the real world, data managed by a system of the disclosure, and functionality of an embodiment of a system in accordance with the disclosure;

FIGS. 2A-2G are block diagrams of an eviction process managed in accordance with the disclosure, wherein the symbol TE indicates a system task in accordance with an embodiment of the disclosure;

FIG. 3 is an environment in accordance with the disclosure, including systems of the disclosure, for managing actions against tenants in breach;

FIG. 4 is a block diagram illustrating a detailed view of an information processing system according to one embodiment of the present disclosure;

FIG. 5 is a detailed editable report of the system showing a status of evictions in a system of the disclosure;

FIG. 6 is a detailed report of properties managed by a system of the disclosure;

FIGS. 7-12 illustrate forms having questions presented for prompting a system user to create a new breach management process using a system of the disclosure; and

FIG. 13 is a task created by a system of the disclosure.

### DETAILED DESCRIPTION OF THE INVENTION

The disclosure provides methods and devices for facilitating evictions or otherwise managing breaches of contract. Users, advantageously landlords or their representatives, agents, attorneys, or employees, access a website operative to carry out aspects of the disclosure via a secure or non-secured logon, from any location supporting network access, for example via LAN or WAN, including the internet. Users may initiate and carry out the requisite steps for conducting an eviction for possession, or for addressing a failure to pay rent, or carry out other tenant obligation.

Software and systems of the disclosure form a platform, collectively system 100, which, in one embodiment, integrates the activities of at least the following three entities:

1. Landlords and/or Property Manager or landlord's agent (collectively, herein, the landlord) who may initiate an eviction or proceeding by entering related data into system 100;

2. Lawyers or legal service providers may (a) be alerted to events, such as an initiated proceeding, (b) receive and accept assigned cases, (c) update cases after negotiations, (d) submit documents and information relating to court appearances and judgments, (e) retrieve and review legal documents that are uploaded by landlords and/or property managers or others, and (f) communicate with landlords and/or property managers and staff supporting aspects of the disclosure (hereinafter support staff), all through use of system 100;

3. Support staff including, but not limited to, customer service, case managers, and admin staff, who may interact with a system 100 implementing the disclosure, to do any of (a) manually update the system with certain steps in the eviction process that are not automated, for example setting a court date as set by a Court, (b) facilitate the progress of the eviction, (c) communicate with both system users, (d) collect payment from users for services provided by a system 100 of the disclosure, and on behalf of legal service providers, process payment for legal services rendered.

Herein, ‘system’ refers to one or more computers executing software to carry out the steps and procedures of the disclosure.

The disclosure manages the eviction process in a systematic manner, consistent with the rules and regulations set by the jurisdiction relating to the proceeding for which a system 100 of the disclosure is employed. The disclosure advantageously centralizes all of the steps, documents, and procedures necessary to promote a tenant's compliance with a lease, or process an eviction of a tenant, from initial filing, through settlement or final lockout, using one or more computer servers. A system of the disclosure advantageously includes functionality for addressing a wide variety of anticipated events in an eviction process, including, but not limited to, tenant defenses in court at various stages, an ability to cancel or hold a case at particular instances, or partial payment in settlement of a landlord tenant dispute.

A system in accordance with the disclosure enables management of complex workflows, with multiple processes which may be relatively non-sequential, based on business rules as defined by a user, typically a landlord or property manager, the system defining software executing upon one or more servers, and user computers connected to the one or more servers by a network. Users may coordinate, carry out, or manage multiple tenant actions or proceedings, including evictions, for multiple properties, and log on to a system of the disclosure in order to manage, update, or check the status of their managed proceedings. Users may, in one embodiment, manage security options relating to use of the system, for example to determine when, how often, and to whom communication and status updates will be delivered. In one embodiment, email is a default form of communication between users of a system of the disclosure, and this may further be set as a default means by a user.

Users interact with servers of the disclosure using a browser, email application, or an executable application, wherein users are presented with html or similar forms, and may click hyperlinks associated with information or steps to be carried out in communicating information to the system. Information is presented to the user upon a screen or other output device, in the form of tables, graphs, and visual images, and may be sent to any known or hereinafter output device. Further in accordance with the disclosure, any or all parts of system 100 may be embodied within a mobile device, such as a laptop, tablet, or cell phone, or may be interacted with using any of the foregoing.

In one embodiment of the disclosure, software provides a self-service facility for clients to initiate, pay for, contribute to, and track an eviction or other process relating to a tenant in breach, and may advantageously be used to implement or coordinate the activities of individuals relating to those processes, including the activities of support staff. Software in accordance with the disclosure may provide services such as accounting or customer relationship management (CRM) services, or may include interfaces for cooperating with known systems for these particular functions.

Self-service in accordance with the disclosure includes initiating and managing a wide variety of tasks associated with a breach without the assistance of experts, except as required by law, including for example appearing before a tribunal in connection with a matter, and further excluding the expertise required to maintain and support system 100. For example, a user of system 100 need not be knowledgeable regarding the process required for evicting a tenant, and will be guided through the necessary steps by system 100. System 100 will prompt a user with appropriate questions, and guide a user through tasks, the tasks selected by system 100 based upon responses to such questions.

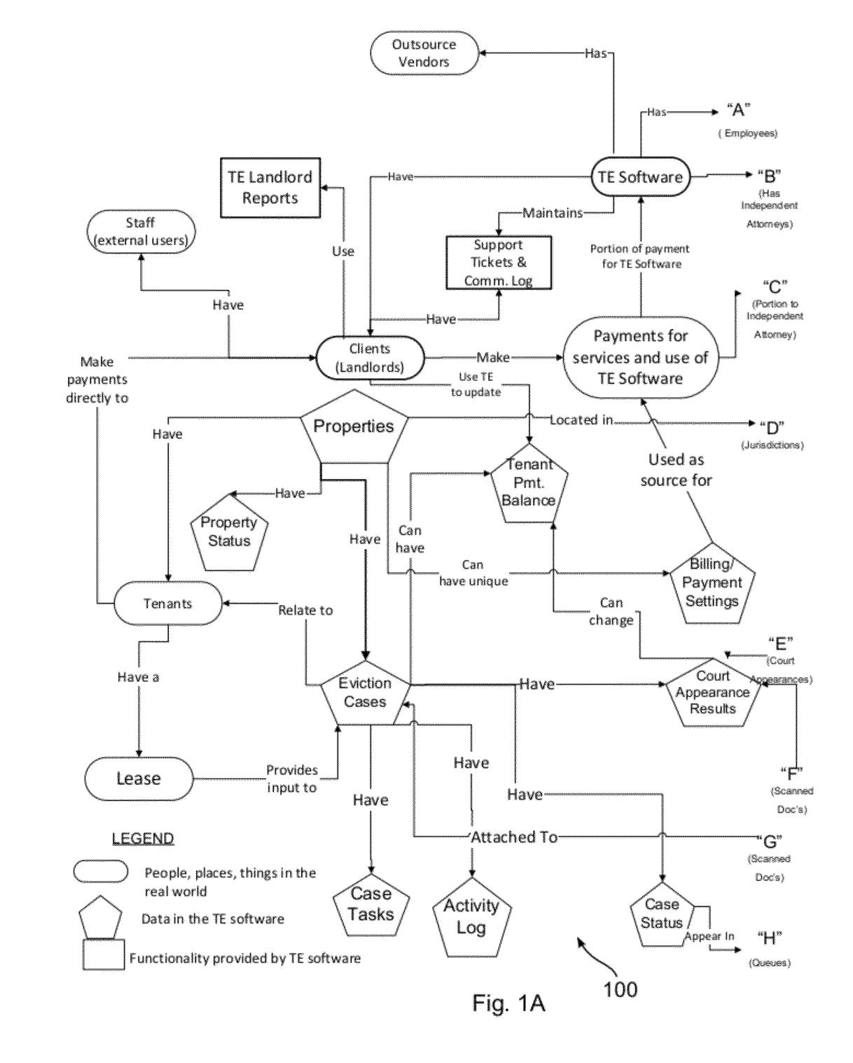

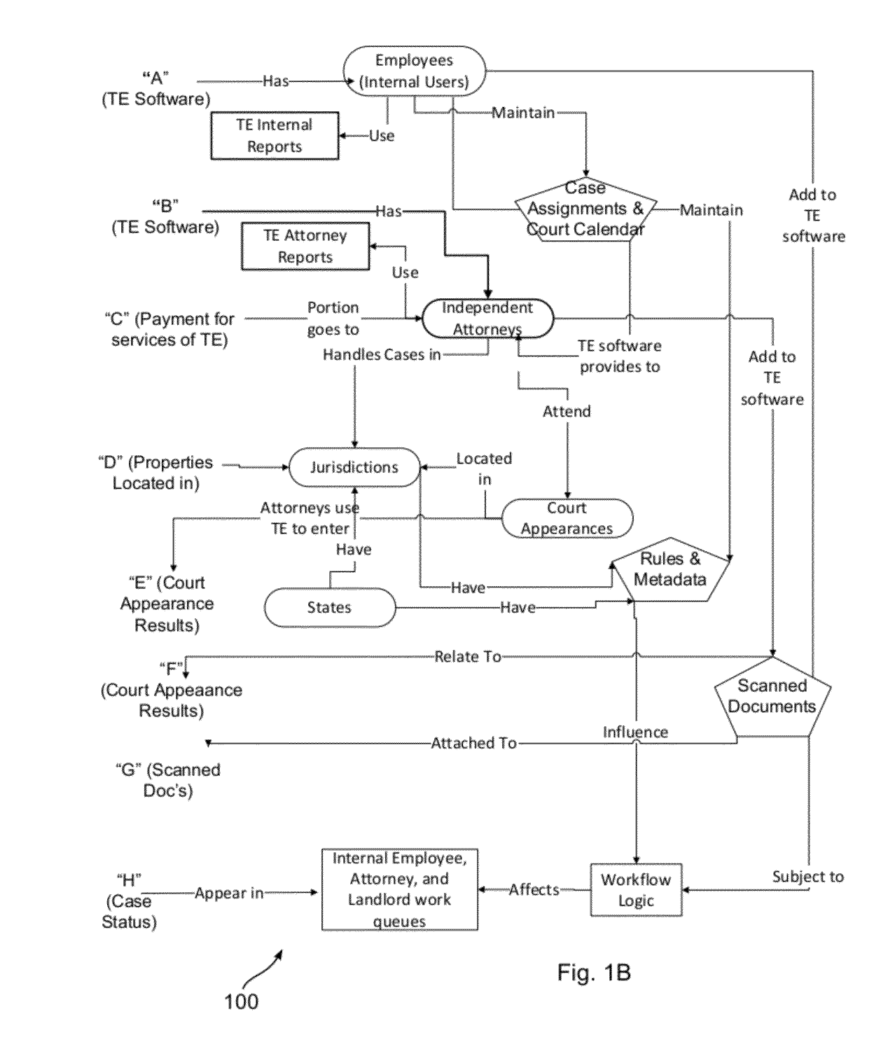

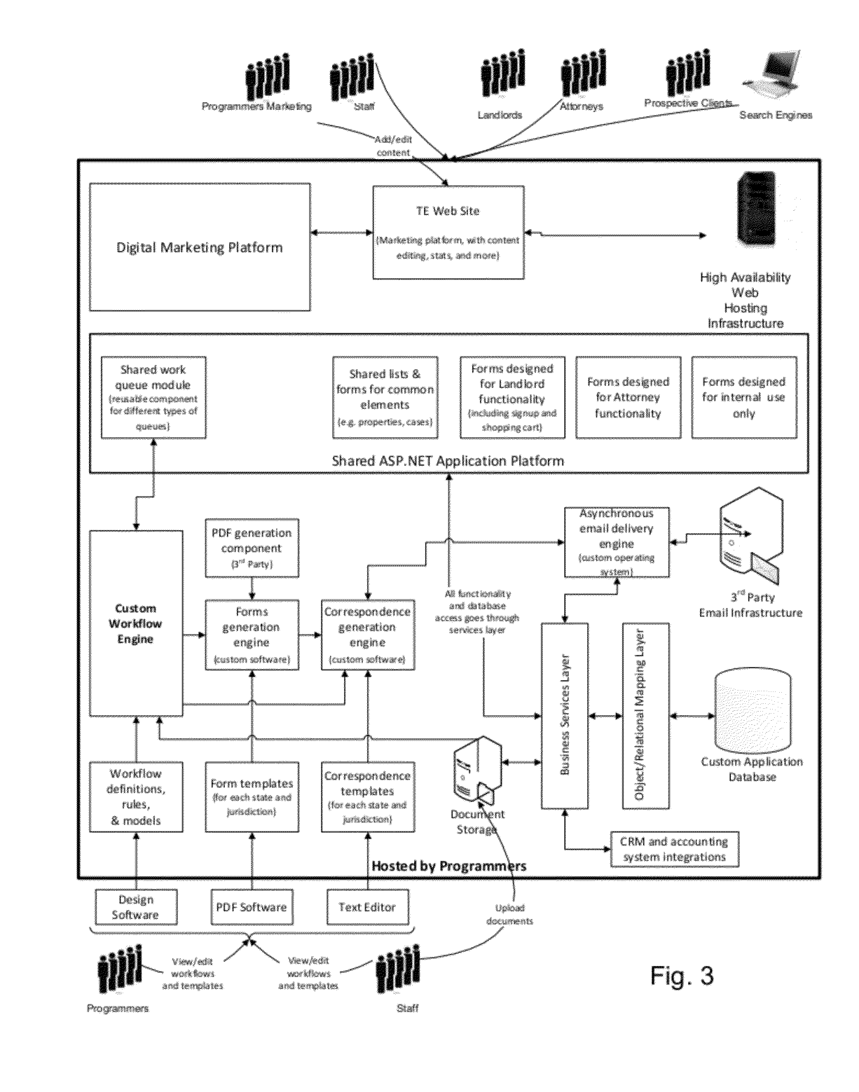

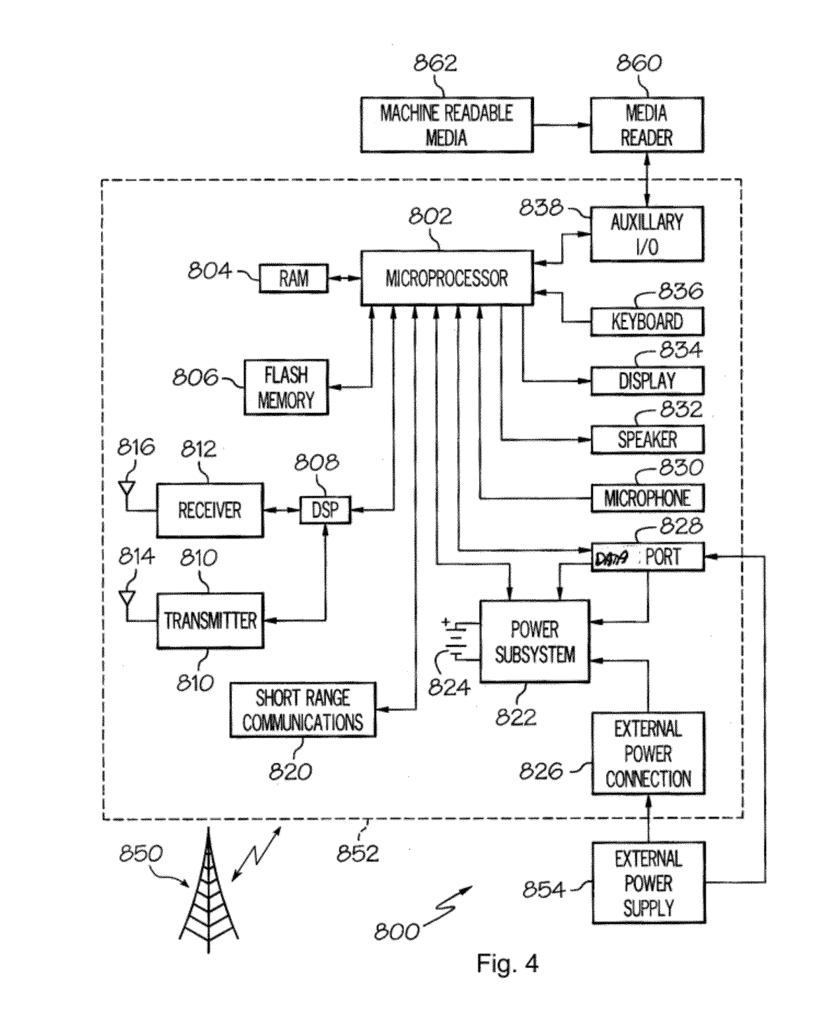

With reference to FIGS. 1A-1B, a flow chart of a system 100 and method in accordance with the disclosure, uses the designation TE for components of the system 100; such designation may, for purposes of this application, be considered to be arbitrary and for reference only. FIGS. 1A and 1B are divided for purposes of available page space, only, and are connected at lines indicated by references “A”-“H”, as indicated. As indicated in the legend provided, objects within an oval indicate people, places, and things in the real world, as distinguished from objects within a pentagon, indicative of data existing in, or managed by a system of the disclosure, or objects within a rectangle, indicative of functionality provided by a system of the disclosure. Connection lines indicate, in text, the nature of a relationship between the elements so connected, read in the direction of the arrow. For example, “Clients (Landlords)” “Have” the functionality of “Support Tickets & Comm. Log”, as shown in FIG. 1A. As such, a process of an embodiment of the disclosure is presented in graphical form, translatable into text in the manner provided in the foregoing example. Software TE of a system of the disclosure is carried out in a computing system, or networked computing environment, as shown and described in FIG. 3 or 4, for example.

It should be understood that the tenancy may be for real property, personal property, chattels, intellectual property, or any other form of tenancy or rental. Further in accordance with the disclosure, an owner is an owner or its representative, including but not limited to a landlord, lessor of any type of property; and, a tenant is a user, occupier, lessee, or other entity that has a duty to the owner in exchange for the use of the owner's property. Further in accordance with the disclosure, an owner may be an attorney, agent, representative, or property manager, acting on behalf of an owner.

It should be understood that system 100 of the disclosure is advantageously used where a legally empowered court, tribunal, or mediation entity, hereinafter a tribunal, generally, has authority to finally resolve a resolution of a breach for a particular type of matter and amount in controversy. Although a process varies between legal jurisdictions, for example between counties or states in the United States, a process generally contains a sequence of progressive steps designed to afford all parties their rights under the highest law of the land, which in the U.S. is the United States Constitution. A party serves notice on the breaching party, and this notice must be in a proper format, and must be served in a timely manner, enabling the other party a reasonable opportunity to respond. System 100 includes software which contains instructions and data to carry out the production of documents having the proper format, and to generate reminders and calendar events which cause these documents to be received in a timely manner. In addition to notice and the proper format, each jurisdiction will define a series of events wherein each party may present evidence relevant to their defense, in the form of motions and pleadings. System 100 advantageously produces these documents, as well, and as with all documents produced, creates the documents as needed based upon inputted data relevant to a particular legal matter, and templates created in advance based upon rules of the applicable jurisdiction. Ultimately, the legal tribunal will issue a decision, and system 100 will create tasks for this event, as with all events of the tribunal, based upon data inputted with respect to the tribunal's decision, or data received directly from the tribunal. System 100 may further advantageously track compliance with the tribunal's decision, and issue reminders as needed to encourage proper compliance.

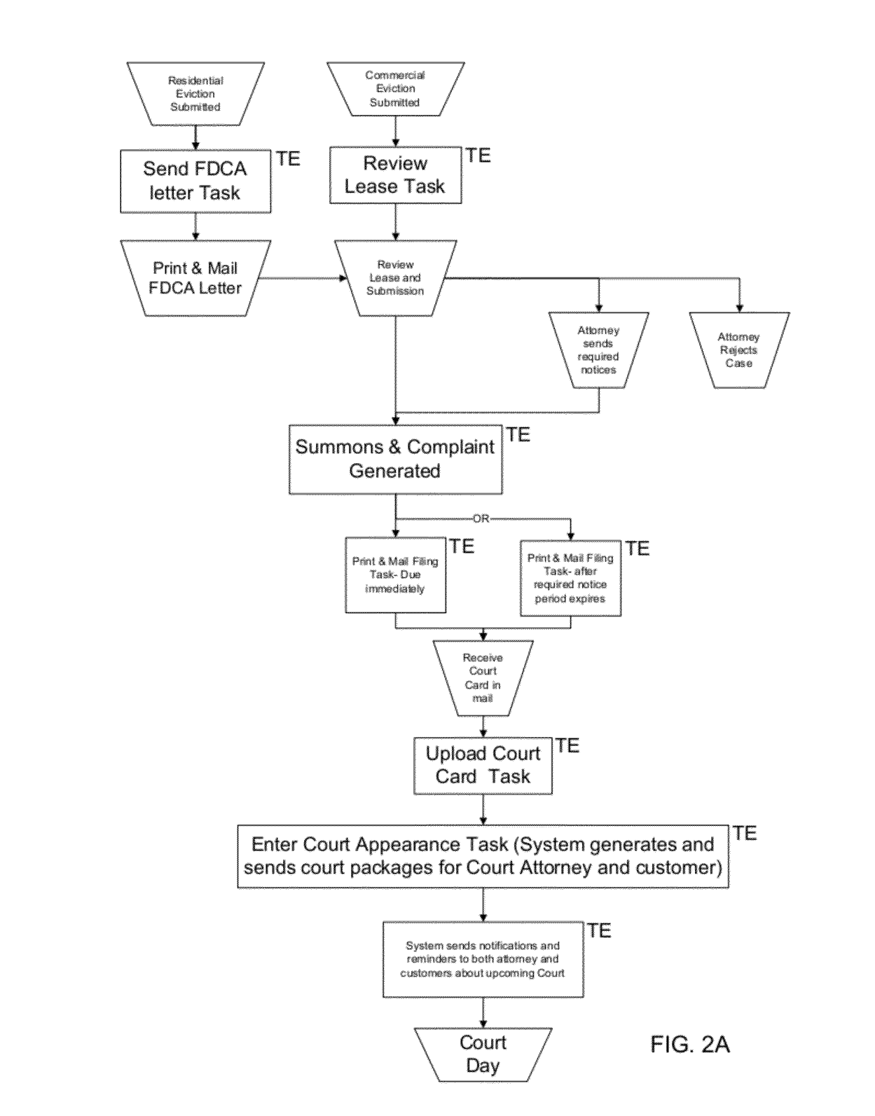

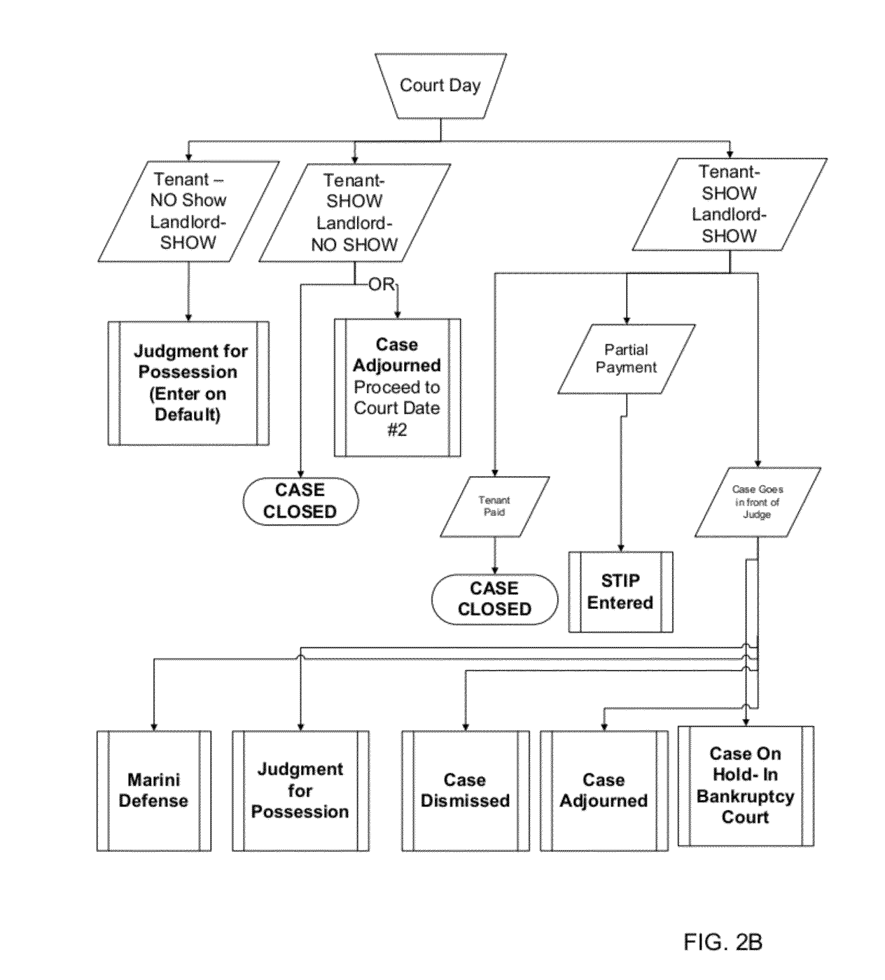

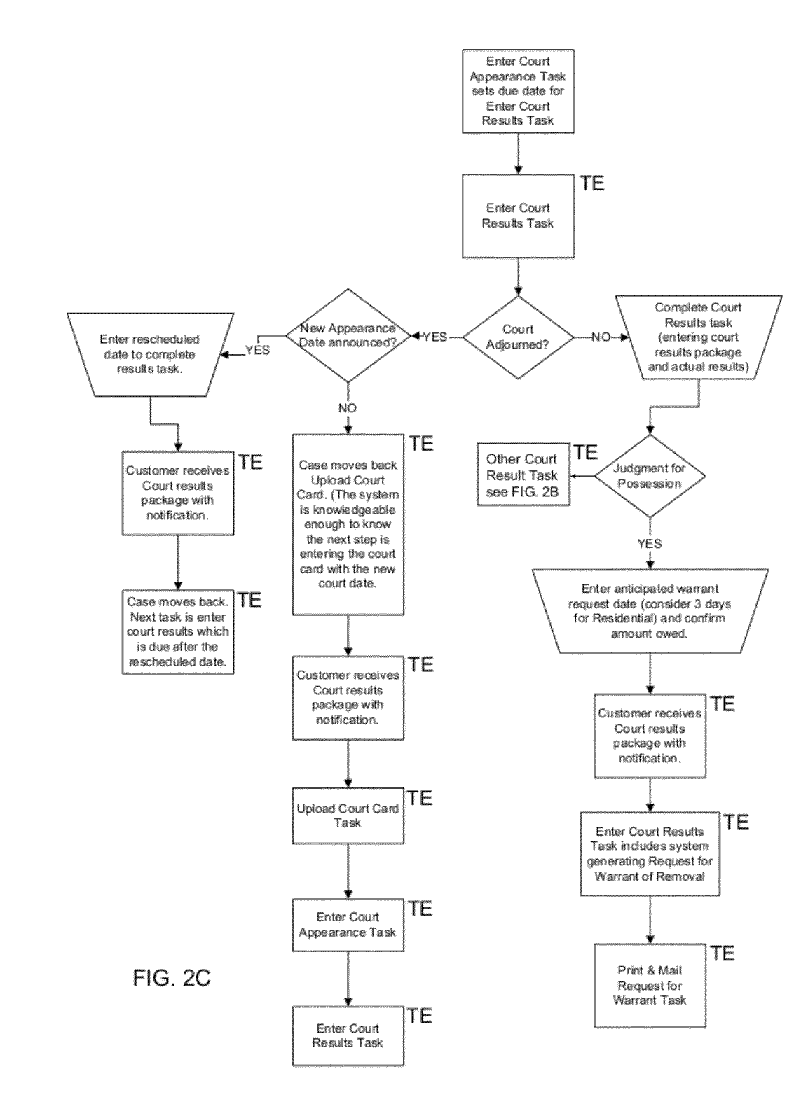

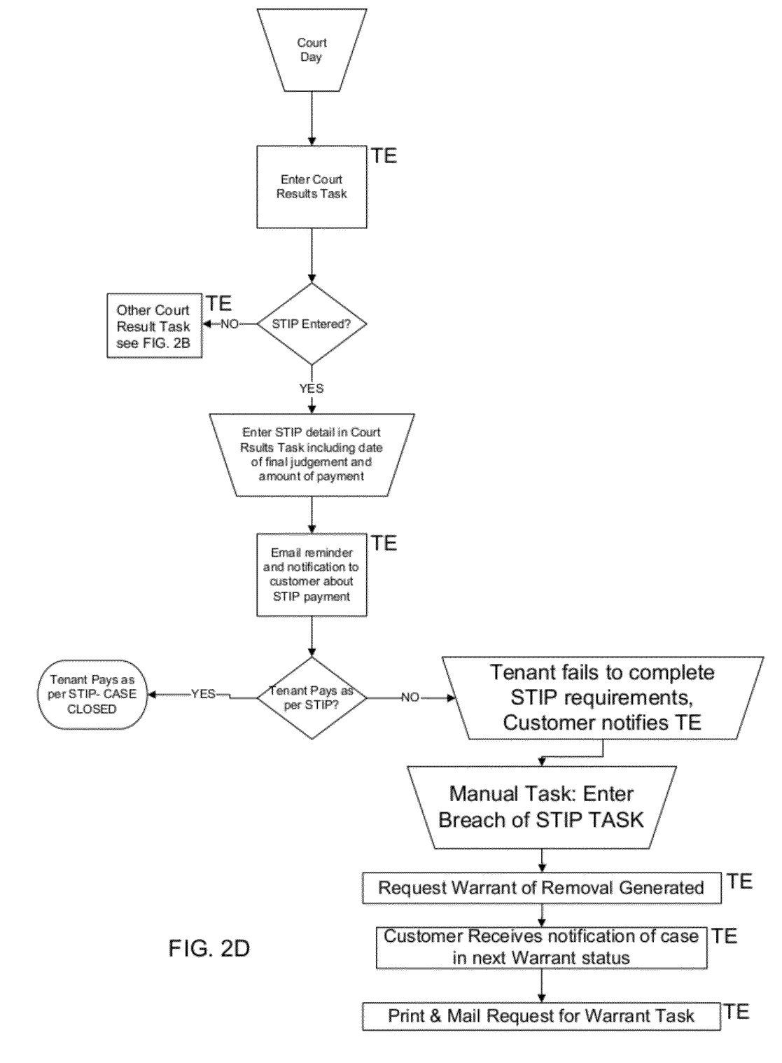

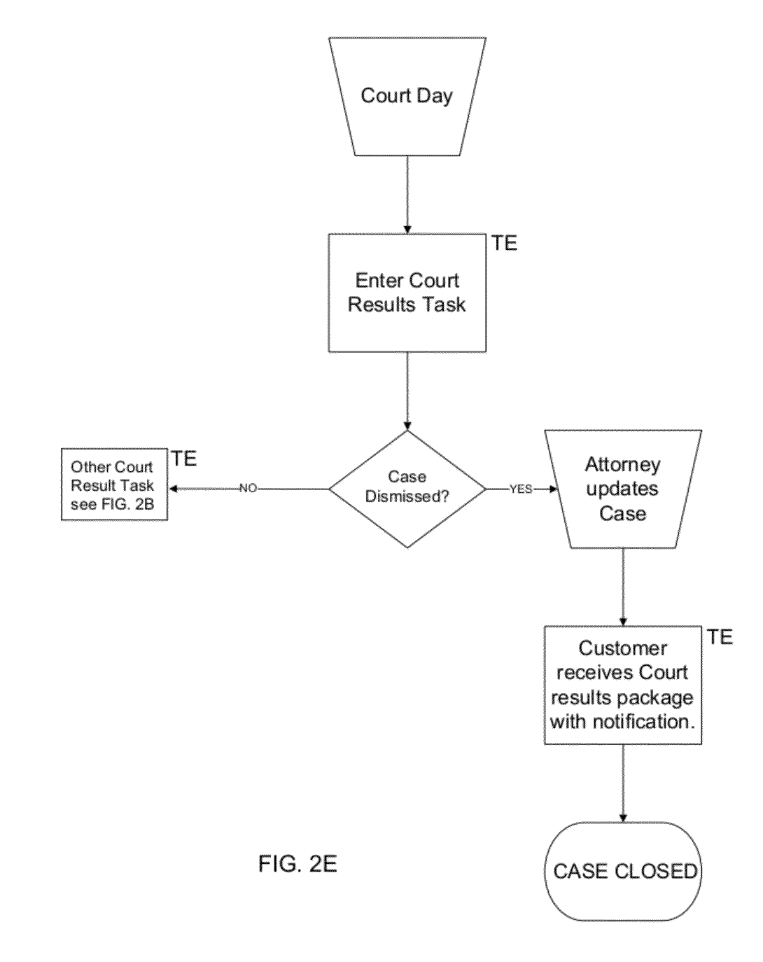

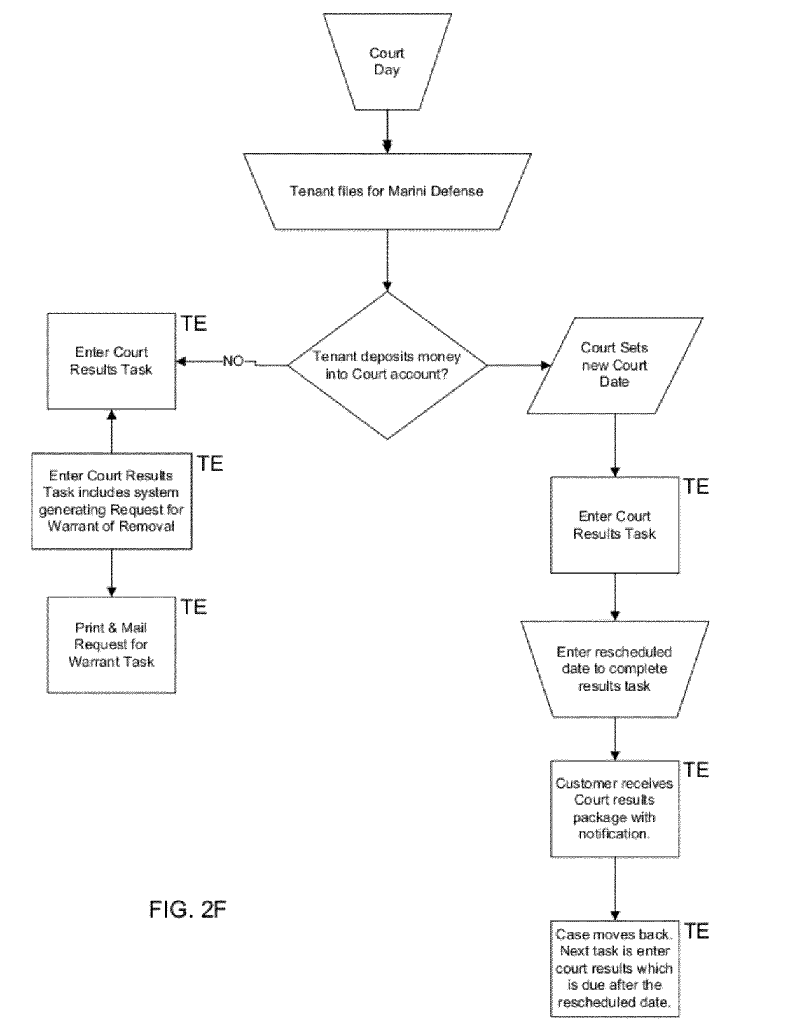

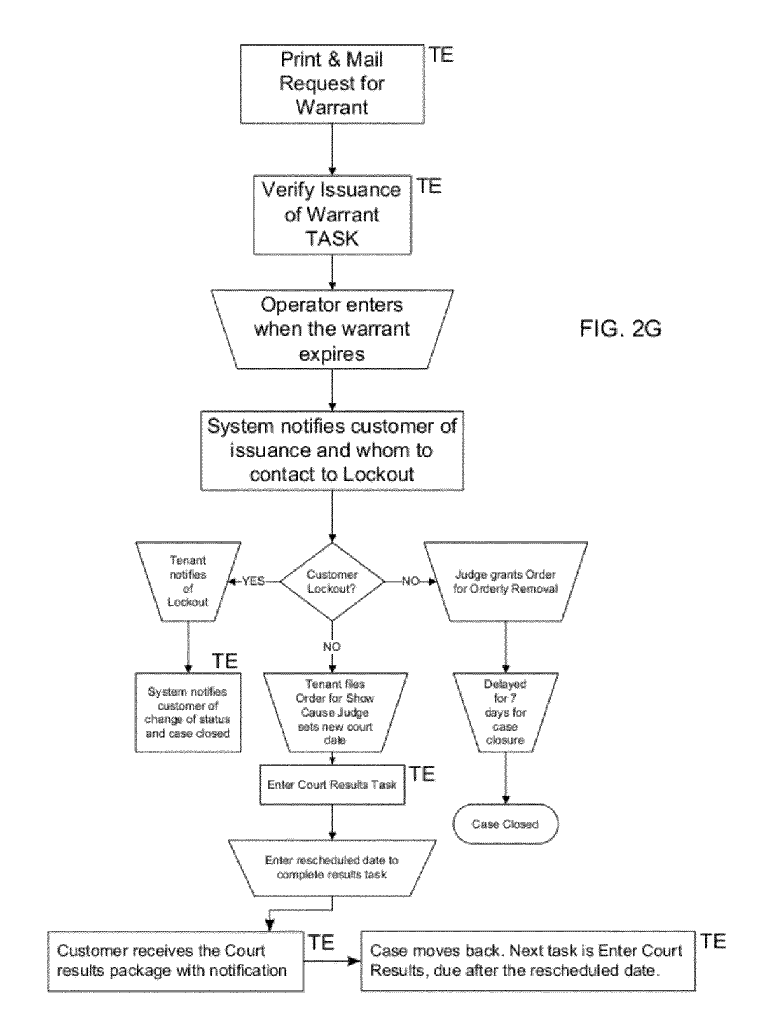

Referring now to FIGS. 2A-2G, a system and method of the disclosure is operative to facilitate management of a breach of a lease by a tenant, by a landlord or lessee or its agent. The flow chart of FIGS. 2A-2G illustrates potential alternative actions or events, and events over time, the events or actions indicated by text within boxes. The flow chart, decision tree, or workflow of FIGS. 2A-2G provides decision tree logic, where a choice is presented to a user of the system by software executing within system 100, for example to a landlord or an attorney, at each logical decision point. Once a decision has been selected, for example with a mouse click, the system guides the user through actions, including for example data collection, form entry, document production, and official filings, until another decision point is reached, at which point the system prompts for another decision, unless a particular tree of the workflow has been completed. The workflow presents an efficient path to resolution of an action for breach, and is modified for each jurisdiction in which the system is to be used.

More particularly, with further reference to FIGS. 2A-2G, in accordance with one embodiment of the disclosure, the symbol “TE” located in an upper left hand corner of a flowchart node indicates a process performed by software executing within a server of system 100. Based upon entered data, including as examples an election of choices by a user, or a date entered into system 100, a task is formed or triggered, as indicated by TE, wherein system 100 undertakes additional steps, as specifically indicated in the respective text of the identified node, to further a management of the breach.

For example, with reference to the top of FIG. 2A, a case is received (by or within a system 100 of the disclosure), after which the breach in this embodiment is identified as commercial or residential. System 100, indicated by TE, then generates a summons and complaint based upon an election to do so, and inputting of the requisite data. Subsequently, the complaint may be filed with a court, or the case may be placed on hold, and so forth. It should be understood that a system in accordance with the disclosure includes software routines and methods for managing the process of FIGS. 2A-2G, including tracking and prompting, through a set of system 100 tasks, a landlord, attorney, or other system 100 user, with respect to the events and data managed by the system, setting calendar dates and reminders for system users, as described herein, preparing follow up messages and sending such messages, and preparing communications between parties, including communications among the tenant, attorneys working on related matters, the court, and other system users, as described in more detail in the flow charts, and elsewhere herein.

In an embodiment of the disclosure, legal service providers, including attorneys, indicate an interest in performing work related to actions by the property owner, including landowners, with respect to breaches by users of property of the owner, including tenants. The legal service providers, in another embodiment, place bids using the system of the disclosure, in order to win awards of work. In this manner, property owners may meet and select legal service providers.

In the embodiment of the disclosure illustrated in FIG. 3, a website in accordance with the disclosure is presented and supported by at least one server, which contains modules and entry forms as shown and described. Illustrative software infrastructure is further shown and described in FIG. 3, together with an interactive relationship among the software elements. Suggested tools for producing components of a system in accordance with the disclosure are additionally illustrated, although it should be understood that other tools may be used. The examples shown include “Visual Studio 2010” and “SQL Server”, products of and registered trademarks of Microsoft Corp. of Redmond, Wash., and “Acrobat”, a product and registered trademark of Adobe Systems, Inc., of San Jose, Calif.

The following are exemplary activities of various individuals connected with actions against breaching or undesired tenants, with respect to their use of a system in accordance with the disclosure (the “system”):

Individual Property Owners: May use the system to manage tenant actions alone, or in cooperation with a legal service provider.

Property Owners Who Have Hired a Property Management Firm: May use the system chiefly for information or reporting.

Ownership/Management of Property Management Companies: May identify useful applications for management by a system of the disclosure, and may use the disclosure for tracking status of cases, managing the timing of eviction processes and cases, and reporting, for example.

Office Employees of Property Management Companies: May initiate eviction processes or other action against tenant, and conduct data entry and reporting.

Field Employees of Property Management Companies: May physically attending court, collecting/recording payments, attending lockouts, and may enter data into the system using a mobile computing device.

Law Firm Employees Hired by Property Owners and Property Management Companies: May carry out eviction processes or other action against tenant, and conduct data entry and reporting.

Management of a system in accordance with the Disclosure: Advantageously have visibility into system statistics (cases, statuses), manage escalations, client service issues, problem cases, and stalled cases, for example.

Staff having responsibilities relating to managing a system in accordance with the disclosure: which advantageously include the tasks of advance workflow; detect and resolve issues, receive paper documents and add them to the system, maintain system metadata (e.g. general data pertaining jurisdictional rules and information, e.g. for municipalities, court locations, and input information related to expected processing times and other parameters relating to the various jurisdictions managed by a system.

Independent Eviction Attorneys: These legal service providers may handle certain aspects of the eviction process that require an attorney, such as attending court proceedings, and may enter results of court proceedings into the system, including uploading electronic copies of documents to the system, and communicating with owner/landlords, and tenant's representatives. In accordance with the disclosure, independent attorneys or other service providers may receive a share of a fee paid by an end client (a landlord or its agent), where the attorney represents the end client. The fee paid by an end client may be a general fee for the use of a system in accordance with the disclosure, which includes anticipated fees to a legal service provider.

Outsourced Call Center Firm: Receives client communications, working tickets, escalating to staff supporting a system of the disclosure, as necessary.

Outsourced Document Handling Firm: May printing, route, store, or otherwise assist in managing electronic or paper documents otherwise managed or relating to use of the system, and may use the system to do so.

Outsourced Accounting Firm: May handle financial accounting relating to use of the system.

A system of the disclosure is advantageously organized into functional areas implemented as modules, for example a series of related web pages, which contain displays, forms, and features that are targeted to particular sets of users. The following is an advantageous organization of a system 100 of the disclosure:

1) a public web site containing marketing and other information pertaining to the system, generally, and including a self-service signup form;

2) a landlord or customer portal, advantageously including secure access, and including an implementation of the system for use by landlords and their agents, to enter details relating to the properties owned or managed by the landlord, as well as the details required to initiate and process an action against a breaching or undesired tenant, including an eviction proceeding, which advantageously includes tenant and lease information;

3) an attorney portal, advantageously secure, and including an implementation of the system for use by attorneys to, for example, view information about eviction cases they may be involved in, view and retrieve court appearance calendars, update cases with results of court proceedings, electronic documents, and other information necessary to process an eviction;

4) a portal for support staff and affiliated entities, for example to manage and support the functionality of a system of the disclosure;

5) a court/tribunal electronic data interchange (EDI) system; and

6) an electronic interchange between system 100 and a court/tribunal appointed officer (e.g. a constable who executes a warrant, for example for eviction).

A system in accordance with the disclosure advantageously includes interfaces for, at least, any of the following functionality, where an interface is an interactive method of exchanging information between a system of the disclosure, and a human or another computing system, including, for example, a browser form, chat interface, data upload, voice prompt/recognition, or other known or as yet unknown method, for the purpose of:

providing contact information or posing questions from a prospective system user, and for accepting terms and conditions for use of the system;

entering and reviewing property and tenant related information, wherein the system automatically determines the applicable jurisdiction based upon stored data and relevant addresses provided by system users, and collects needed information relating to the requirements thereof;

viewing actions in process and their activity status, including status with respect to readiness for initiation;

entering and reviewing detailed tenant, tenant action, and or prior or current eviction information, including involvement by government entities, funds owed, and lease information;

creating a new tenant related action based on a previous one;

paying for a system service, such as an eviction, for example an ecommerce shopping cart, including discounts;

filtering active, inactive, and pending activities;

accessing details relating to a particular action against a tenant, including entering and viewing documents, changing a status of the action, and entering and reviewing notifications;

searching for properties or entities entered into the system;

managing user accounts and permitted activities;

managing options provided by the system;

defining import or export properties and methods;

requesting support for the system;

entering and managing stipulations or settlements, including missed, partial or complete payments by tenants;

communicating system notices, errors, and events to users of the system;

communicating notices of events relating to activities managed by the system, including court dates, payments dates, moving dates, and lease related dates;

reporting activities and events managed by the system; and

sending information within the system by email, as directed by system users.

Communication of information, including for example notices, tribunal information, and messages, advantageously takes place in real time. Herein, real time means within the reasonably short delay generally attributed with the storage and transmittal of information by computer systems over networks, where it is understood that lengthy delays may occasionally be incurred, but are due to failures or extraordinary circumstances.

A system in accordance with the disclosure supports single or multiple users. For example, one or more than one person may be involved in the eviction process. A multi-employee property management firm might have only one person who handles evictions, in which case they might only need a single user version of a system of the disclosure. A single vs. multiple user may determine how the software looks and works; for example, a single user configuration would not have a menu item for defining users and assigning roles.

For attorneys, in particular, an interface is advantageously provided for the purposes, functions, or one or more of the tasks detailed in Table 1.

TABLE 1
Attorney Interfaces and Functions

| Task | Additional Description |
|---|---|
| View tabular case | Online view of case calendar, with drill-down links to individual cases. |
| calendar for | |
| upcoming cases | |
| View calendar | Calendar view(s) showing an attorney's court appearances. |
| view case calendar | |
| Print tabular case | The case calendar is a tabular list of court appearances, with each report |
| calendar | targeted to an individual attorney, or a group of attorneys working |
| | together; each page of a report is advantageously for a single date for a |
| | single attorney; many attorneys will make notations on the printed report |
| | during the court proceedings and may use those notations as the source |
| | for entering the results into the system later. |
| View tabular case | After a day of court appearances is completed, the attorney, or possibly a |
| calendar for | paralegal, may enter the results of the court proceedings into the system; |
| completed | this may advantageously be performed directly in an input queue, |
| appearance as a | without needing to drill into each case record. When the results are |
| work queue | entered the attorney may indicate whether there are scanned documents |
| | that also need to be added, which advantageously places the case in a |
| | “holding for documents” status, until the scanned documents are |
| | uploaded. If a case stays in the “holding for documents” status too long, |
| | escalations and reminders would start being issued by the system. |
| Enter single set of | This is an editable form for an individual case; if for some reason the |
| court proceeding | attorney drills into an individual case record, he can add whatever court |
| results on | results or other day that is required. |
| individual case | |
| record | |
| Upload one or | While the attorney may be expected to enter the results of court |
| more scanned | proceedings directly onto a case record of the system, this is not the case |
| documents for one | with scanned documents that relate to the case; the documents would |
| or more cases | usually be court documents, but sometimes also correspondence, photos, |
| | and receipts; while an attorney may directly add documents to the system |
| | him/herself, in accordance with the disclosure, it is advantageous for all |
| | documents to enter a document queue, where they are reviewed and |
| | processed by a plurality of different data entry operators, for example |
| | two individuals, who will examine the actual documents in order to |
| | ascertain/validate what type of document they are, and which case the |
| | belong to, and whether they are sufficiently legible. |
| Add document via | The email subject would advantageously have an identifying number or |
| email | code associated with the attorney by the system, which tells the system of |
| | the source of the document. |
| Add document via | Fax cover sheet advantageously have a barcode that drives |
| fax | routing/workflow within the system. |
| Print general or | This function facilitates entry of paper documents into the system, by |
| case-specific | associating information on the cover sheet known by the system with the |
| attorney document | document to be entered into the system. |
| scan cover sheet | |
| Add to client | This function facilities tracking communications and events associated |
| communication | with a client or specific activity. |
| log | |

A system in accordance with the disclosure additionally advantageously enables one or more of the tasks described in Table 2, typically performed by system support staff, to maintain and support the system.

TABLE 2
System Support Tasks

| Task | Additional Description |
|---|---|
| view/use work queues | |
| view clients list | |
| view client detail | |
| view properties list | |
| view property detail | |
| view eviction cases list | |
| view eviction case detail | |
| add scheduled court appearance to | When a court case is scheduled, the case must be |
| case | updated to that effect--see also related workflow queue, |
| | attorney assignment, and case calendar functionality |
| view system overview | a dashboard with statistics such as total clients, new |
| | clients, total properties, new properties, number of new |
| | clients who have not added properties yet, and |
| | properties aging in an incomplete status, for example |
| manage system options | view/edit certain “global settings” that control the |
| | landlord or attorney application components of the |
| | system, the system itself, including, for example, |
| | automated processes of the system |
| manage lookup data and/or | |
| managed metadata | |
| add to client communication log | add a record to the communication log manually— |
| | advantageously, correspondence generated by the |
| | system, electronic or paper, will have a record added to |
| | the communication log automatically, and a customer |
| | support ticketing system will update the communication |
| | log |
| manage jurisdictional metadata | each state and jurisdiction has its own rules, procedures, |
| | and forms--logic in the system is driven by inputs from |
| | metadata that is specific to states and their jurisdictions, |
| | for example the number of expected days to receive an |
| | “Index Card” document for an eviction case from a |
| | given county's court would be an input to the logic of |
| | when the system should escalate a case that has been in |
| | the status of “waiting for index card” for some time |
| manage workflow rules and routing | |
| manage users and permissions | defining roles, mapping roles to established permissions, |
| | creating users, mapping users to roles, and |
| | deactivating/deleting users |
| manage law firm and attorney data | including jurisdictions in which specific attorneys may |
| | practice |
| manage form templates | e.g. for each jurisdiction |
| manage correspondence templates | |
| add one or more scanned | |
| documents as files | |
| add batch of scanned documents | |
| with imaging technology | |

In accordance with the disclosure, workflows are provided, wherein creating, or instantiating certain data elements or actions triggers subsequent steps or events. Non-limiting examples are provided in Table 3.

TABLE 3
Examples of Workflow Triggers

| Action | Triggered Workflow Events |
|---|---|
| Creation of a new | Account verification, sending of notifications to the client, including |
| client/landlord | information about the system and its services, and follow up |
| | assistance for entering property, lease, and tenant information, as |
| | well as payments and payment information. |
| Creation of cases | A complex workflow includes auto-assignment to Attorney. |
| Submission of | Entry into a validation Document Queue, whereby a document is |
| documents | checked, advantageously by two individuals, for accuracy, legibility, |
| | and attachment/routing to appropriate case records, as well as the |
| | identification and handling of exception. |
| New court appearances | entry into the cases workflow, entering of results, and attachment of |
| | documents. |
| Case Exceptions and | routing to human evaluator/resolver |
| Escalations | |
| Document Resolution | Documents without identifying information or barcode are identified |
| | by a human or system 100 and routed appropriately |
| Illegible Documents | Replacement documents are requested, based upon an original bar |
| | code placed on the document during initial scanning. |
| Dual Entry Mismatch | Conflicts between different Document Queue processors are |
| Documents | resolved between the processors, or by a supervisor. |
| Attorney Cases and | System functions are activated to filter/sort by customer, court date, |
| Appearances | and/or jurisdiction; could include court dates or other non-court |
| | actions that require the attorney to take the action; also includes |
| | Appearances that have already occurred and are awaiting results |
| | data and/or documentation. |
| Calendar Queue | System process or “calendar clerk” enters reminder dates regarding |
| | pending court cases and events, for all attorneys |
| Customer Support | Support tickets are initiated by customers, service personnel, or a |
| Tickets | system process. |
| Automated Background | System processes my run simultaneously, with one or more tasks |
| Processors | being performed in a hidden state, or at a lower priority, with respect |
| | to a process that is being viewed by a human user. The following |
| | four actions, for example, are advantageously performed using |
| | background processing. |
| Document Entry | A system process which, after a document in the Document Entry |
| Validator | queue has been processed by, for example, two operators, or after a |
| | previously flagged document entry has been resolved, this process |
| | ensures that the data is valid, based on other data within the system, |
| | and if so, commits the document and data to the case record. |
| Case Status Evaluator | A system process which evaluates recently added or updated |
| | eviction cases to determine if requirements have been met to change |
| | the status, which might also involve sending a notification. |
| Case Notification | A system process which identifies emails notifications that need to |
| Evaluator | be sent for cases, properties, documents, etc. for all types of users |
| Payment Information | A system process which identifies client payment information that is |
| Aging Evaluator | expiring or has expired, and sends email notifications or creates |
| | internal action items prompting a user to update. |

System processes are carried out by software executing upon one or more servers.

In accordance with the disclosure, reports, documents, and forms are produced by system 100, as files for output to a display device, or as lists presented upon a display device, for example a computer monitor or printer. Output files may be provided in any of a variety of file formats, including spreadsheet, delimited, or text formats. Example reports are presented in Table 4.

TABLE 4
Example Reports

| Report Area | Description | Additional Detail |
|---|---|---|
| Landlord | Property lists | |
| Reports | | |
| | Property detail | |
| | Case lists | |
| | Case detail/histories | |
| Attorney | Attorney Case | Shows all upcoming court dates and jurisdictions for a |
| Reports | Calendar Overview | single attorney |
| | Client Case | Shows all upcoming court dates and jurisdictions for a |
| | Calendar Overview | single Client and Case |
| | Court Case Calendar | A single list of all cases scheduled for a field attorney |
| | Summary | on a given date in a given jurisdiction |
| | Field Attorney | A generic cover sheet that can be used for adding |
| | General Fax/Scan | documents to the system outside of the Court Result |
| | Barcode Sheet | Form |
| | Customer-Case | Printed from the detail page for an individual case so |
| | Document Cover | that an attorney or other user can use it as a cover sheet |
| | Sheet | for uploading, emailing, or faxing documents |
| Internal/ | Accounting reports | Support a reconciliation process: match up system |
| Management | necessary for | transactions with payment processor transaction, with |
| Reports | reconciliation | outsourced accounting system reports with court |
| | | records/transactions |

A system in accordance with the disclosure may integrate with other systems to perform certain tasks, or portions of tasks, for example: 3rd party payment processor; email processor; outsourced accounting vendor/system; customer support/ticket tracking system; and CRM system for converting prospects to clients and for tracking/enabling marketing to existing customers. Other functionality for which third party systems are available for integration, include external SaaS (Software as a Service) or COTS (commercial off the shelf) systems, including payment processing; GL accounting; customer service tickets; and CRM and sales support.

In accordance with the disclosure, the following additional functionality is advantageously supported by a system of the disclosure: uploading of property and other data via a CSV or other file import format; distinct payment arrangements and accounts per property; additional system user role types and more granular permission control for type of user; assignment of certain users to certain properties; third party email processor portal for marketing and round trip integration to record opens and click-throughs; mobile computing and/or phone application interface for users, including attorneys and clients; courthouse EDI (electronic data interchange) integration or other data exchange with a court or tribunal; and state/jurisdiction-specific workflows and multi-jurisdictional workflow customizations. Data interchange among all system 100 users is additionally advantageously supported by system 100, wherein each system 100 user may enter and receive data in bulk format with system 100, and may send or receive data from other software or systems, for analysis and use outside of system 100, or analysis or other use within system 100.

In a further embodiment of the disclosure, a system of the disclosure is created using a general purpose programming language, including but not limited to HTML, Javascript or Java (registered marks of Sun Microsystems, Inc., of Santa Clara, Calif.), or any of the variations of the languages C, BASIC, Perl, ASP, or PHP, or a domain specific language (DSL).

An exemplary process flow in accordance with one embodiment of the disclosure, includes the following: all documents entering the system go through a Document Entry queue, and have either identifying information directly on the document, or are accompanied by a cover sheet that includes the identifying information, or bear a barcode identifying the document; the cover sheet, if used, is printed from the system by the person providing the document; “Identifying Information” for documents is defined as any information that allows a Document Entry clerk or the system to determine which customer and case the document relates to, or related court appearance, where applicable; documents going into the Document Entry queue will go through the processing steps of (a) review for legibility, (b) identify customer/case/appearance to which the document correlates, (c) enter relevant data from the document and/or cover sheet into the system; all documents going into the Document Entry queue are advantageously processed by two separate clerks; once a document in the Doc Entry queue has been processed by two clerks, the system will verify that the results match exactly before the document/data can be committed to the case record.

Documents may have any known form, examples including index cards, stipulation forms, receipts; photos, and Marini repair lists. Attorneys may add documents to the system via any known method, including for example direct upload, email of PDF/TIFF attachments, scan, or fax. When a field attorney uploads, emails, or faxes in documents, the communication advantageously includes an identifier for the source of the document, which provides a way for a Document Entry clerk or the system to follow up with the person if there is a legibility problem or other problem.

A system of the disclosure advantageously includes an ability to perform character recognition on scanned or uploaded documents, in order to analyze the document contents, for example using software routines, possibly including artificial intelligence or logic routines, and to perform processing of the document as described herein, without human intervention.

Additional embodiments of the disclosure include the functionality of distinguishing handling of public and private information, according to the system user; providing individual or grouped/“digest” information, for example in the form of emails; organizing jurisdictional metadata to include formatting patterns/masks for information, including for example docket numbers, so that the system can normalize input based on this metadata when users are entering data in the system, or at other times, for example in a background process; enable users to manage activities of the system in a self-service fashion, including requesting services, receiving notifications, providing payment, and viewing the status of services; create informative updates or information of interest in the form of a blog; facilitate creation and posting of blog entries.

One or more web pages comprising a resource area may advantageously form a part of system 100, the resource area including one or more downloadable forms, help information, useful links, resource literature, and or other materials which are useful in understanding system 100, the environment in which system 100 is employed, or in carrying out functions and activities which are typically associated with endeavors relating to the use of system 100.

A system in accordance with the disclosure advantageously is adapted to facilitate management and resolution of any action against a tenant in breach, including for example non-payment, residential; other breach of lease, residential; non-payment, commercial; other breach of lease, commercial; other actionable events, as defined in each jurisdiction supported by the system.

FIG. 4 is a block diagram of an electronic device and associated components 800 in which the systems and methods disclosed herein may be implemented. In this example, an electronic device 852 is a wireless two-way communication device with voice and data communication capabilities. Such electronic devices communicate with a wireless voice or data network 850 using a suitable wireless communications protocol. Wireless voice communications are performed using either an analog or digital wireless communication channel. Data communications allow the electronic device 852 to communicate with other computer systems via the Internet. Examples of electronic devices that are able to incorporate the above described systems and methods include, for example, a data messaging device, a two-way pager, a cellular telephone with data messaging capabilities, a wireless Internet appliance or a data communication device that may or may not include telephony capabilities.

The illustrated electronic device 852 is an example electronic device that includes two-way wireless communications functions. Such electronic devices incorporate communication subsystem elements such as a wireless transmitter 810, a wireless receiver 812, and associated components such as one or more antenna elements 814 and 816. A digital signal processor (DSP) 808 performs processing to extract data from received wireless signals and to generate signals to be transmitted. The particular design of the communication subsystem is dependent upon the communication network and associated wireless communications protocols with which the device is intended to operate.

The electronic device 852 includes a microprocessor 802 that controls the overall operation of the electronic device 852. The microprocessor 802 interacts with the above described communications subsystem elements and also interacts with other device subsystems such as flash memory 806, random access memory (RAM) 804, auxiliary input/output (I/O) device 838, data port 828, display 834, keyboard 836, speaker 832, microphone 830, a short-range communications subsystem 820, a power subsystem 822, and any other device subsystems.

A battery 824 is connected to a power subsystem 822 to provide power to the circuits of the electronic device 852. The power subsystem 822 includes power distribution circuitry for providing power to the electronic device 852 and also contains battery charging circuitry to manage recharging the battery 824. The power subsystem 822 includes a battery monitoring circuit that is operable to provide a status of one or more battery status indicators, such as remaining capacity, temperature, voltage, electrical current consumption, and the like, to various components of the electronic device 852.

The data port 828 of one example is a receptacle connector 104 or a connector that to which an electrical and optical data communications circuit connector 800 engages and mates, as described above. The data port 828 is able to support data communications between the electronic device 852 and other devices through various modes of data communications, such as high speed data transfers over an optical communications circuits or over electrical data communications circuits such as a USB connection incorporated into the data port 828 of some examples. Data port 828 is able to support communications with, for example, an external computer or other device.

Data communication through data port 828 enables a user to set preferences through the external device or through a software application and extends the capabilities of the device by enabling information or software exchange through direct connections between the electronic device 852 and external data sources rather then via a wireless data communication network. In addition to data communication, the data port 828 provides power to the power subsystem 822 to charge the battery 824 or to supply power to the electronic circuits, such as microprocessor 802, of the electronic device 852.

Operating system software used by the microprocessor 802 is stored in flash memory 806. Further examples are able to use a battery backed-up RAM or other non-volatile storage data elements to store operating systems, other executable programs, or both. The operating system software, device application software, or parts thereof, are able to be temporarily loaded into volatile data storage such as RAM 804. Data received via wireless communication signals or through wired communications are also able to be stored to RAM 804.

The microprocessor 802, in addition to its operating system functions, is able to execute software applications on the electronic device 852. A predetermined set of applications that control basic device operations, including at least data and voice communication applications, is able to be installed on the electronic device 852 during manufacture. Examples of applications that are able to be loaded onto the device may be a personal information manager (PIM) application having the ability to organize and manage data items relating to the device user, such as, but not limited to, e-mail, calendar events, voice mails, appointments, and task items.

Further applications may also be loaded onto the electronic device 852 through, for example, the wireless network 850, an auxiliary I/O device 838, Data port 828, short-range communications subsystem 820, or any combination of these interfaces. Such applications are then able to be installed by a user in the RAM 804 or a non-volatile store for execution by the microprocessor 802.

In a data communication mode, a received signal such as a text message or web page download is processed by the communication subsystem, including wireless receiver 812 and wireless transmitter 810, and communicated data is provided the microprocessor 802, which is able to further process the received data for output to the display 834, or alternatively, to an auxiliary I/O device 838 or the Data port 828. A user of the electronic device 852 may also compose data items, such as e-mail messages, using the keyboard 836, which is able to include a complete alphanumeric keyboard or a telephone-type keypad, in conjunction with the display 834 and possibly an auxiliary I/O device 838. Such composed items are then able to be transmitted over a communication network through the communication subsystem.

For voice communications, overall operation of the electronic device 852 is substantially similar, except that received signals are generally provided to a speaker 832 and signals for transmission are generally produced by a microphone 830. Alternative voice or audio I/O subsystems, such as a voice message recording subsystem, may also be implemented on the electronic device 852. Although voice or audio signal output is generally accomplished primarily through the speaker 832, the display 834 may also be used to provide an indication of the identity of a calling party, the duration of a voice call, or other voice call related information, for example.

Depending on conditions or statuses of the electronic device 852, one or more particular functions associated with a subsystem circuit may be disabled, or an entire subsystem circuit may be disabled. For example, if the battery temperature is low, then voice functions may be disabled, but data communications, such as e-mail, may still be enabled over the communication subsystem.

A short-range communications subsystem 820 provides for data communication between the electronic device 852 and different systems or devices, which need not necessarily be similar devices. For example, the short-range communications subsystem 820 includes an infrared device and associated circuits and components or a Radio Frequency based communication module such as one supporting Bluetooth® communications, to provide for communication with similarly-enabled systems and devices, including the data file transfer communications described above.

A media reader 860 is able to be connected to an auxiliary I/O device 838 to allow, for example, loading computer readable program code of a computer program product into the electronic device 852 for storage into flash memory 806. One example of a media reader 860 is an optical drive such as a CD/DVD drive, which may be used to store data to and read data from a computer readable medium or storage product such as computer readable storage media 862. Examples of suitable computer readable storage media include optical storage media such as a CD or DVD, magnetic media, or any other suitable data storage device. Media reader 860 is alternatively able to be connected to the electronic device through the Data port 828 or computer readable program code is alternatively able to be provided to the electronic device 852 through the wireless network 850.

The present subject matter can be realized in hardware, software, or a combination of hardware and software. A system can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein.

In accordance with the disclosure, one or more software modules of system 100 exchange data, including import and export of data, with external or separate software applications, including real estate, property management, accounting, asset tracking, or other application which may advantageously be used in cooperation with system 100 of the disclosure.

Further in accordance with the disclosure, data stored and or communicated by system 100 is encrypted or secured against unauthorized access during part or all of its transmission and or residence within system 100, and between systems connected to system 100 and system 100.

Additionally, system 100 advantageously includes software having a function of ensuring timely backup of data and or redundancy of data used or managed by system 100.

The present subject matter can also be embedded in a computer program product, which comprises all the features enabling the implementation of the methods described herein, and which—when loaded in a computer system—is able to carry out these methods. Computer program in the present context means any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include computer readable storage medium embodying non-volatile memory, such as read-only memory (ROM), flash memory, disk drive memory, CD-ROM, and other permanent storage. Additionally, a computer medium may include volatile storage such as RAM, buffers, cache memory, and network circuits. Furthermore, the computer readable medium may comprise computer readable information in a transitory state medium such as a network link and/or a network interface, including a wired network, or a wireless network, that allow a computer to read such computer readable information.

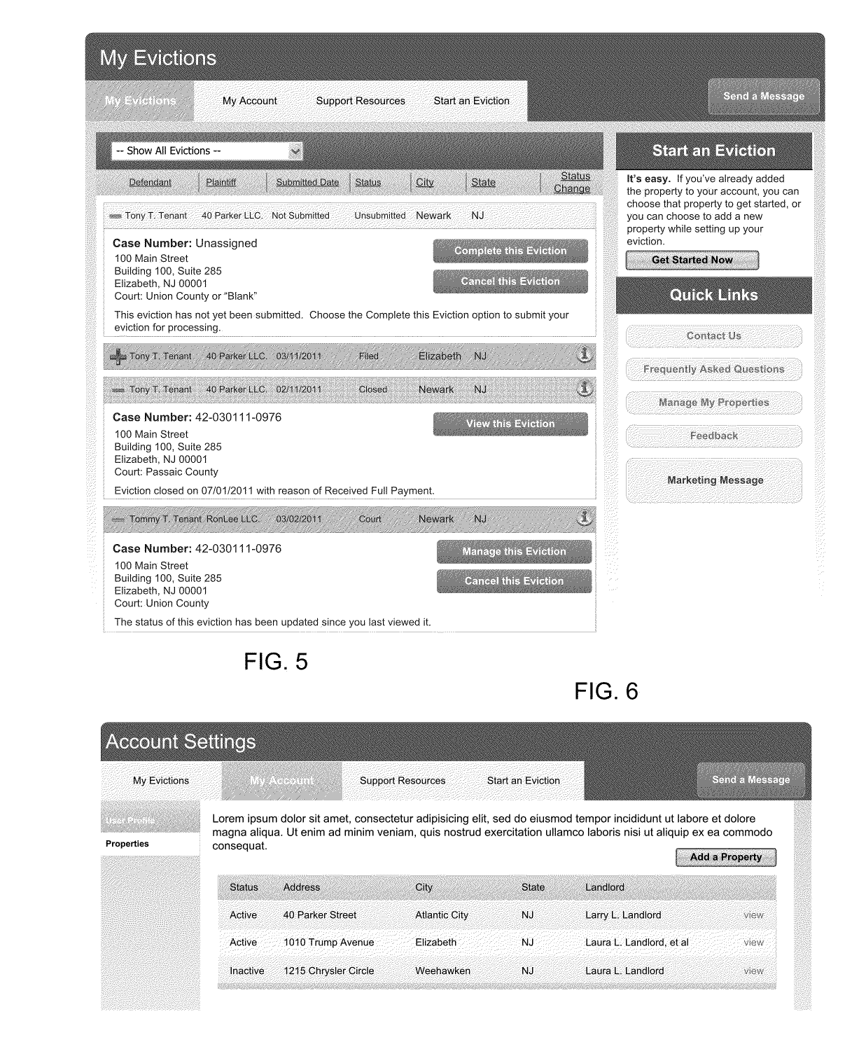

Further in accordance with the disclosure, and with reference to FIG. 5, system 100 transforms inputted data in the form of a consolidated array of all pending evictions for a given landlord. Where a case number has been assigned, this data is presented. For each record, a user may request to view more or less information pertaining to the eviction. In addition, a user may manage a selected eviction, for example by adding or changing data associated with the eviction. System 100 tracks these changes, and updates displayed data for all system users in real time, as permitted by the speed of the components of system 100, and an associated network.

Similarly, in FIG. 6, an authorized user may manage properties associated with a landlord. In this manner, once a property is entered into system 100, the details of the property may be retrieved without a requirement for reentering such data.

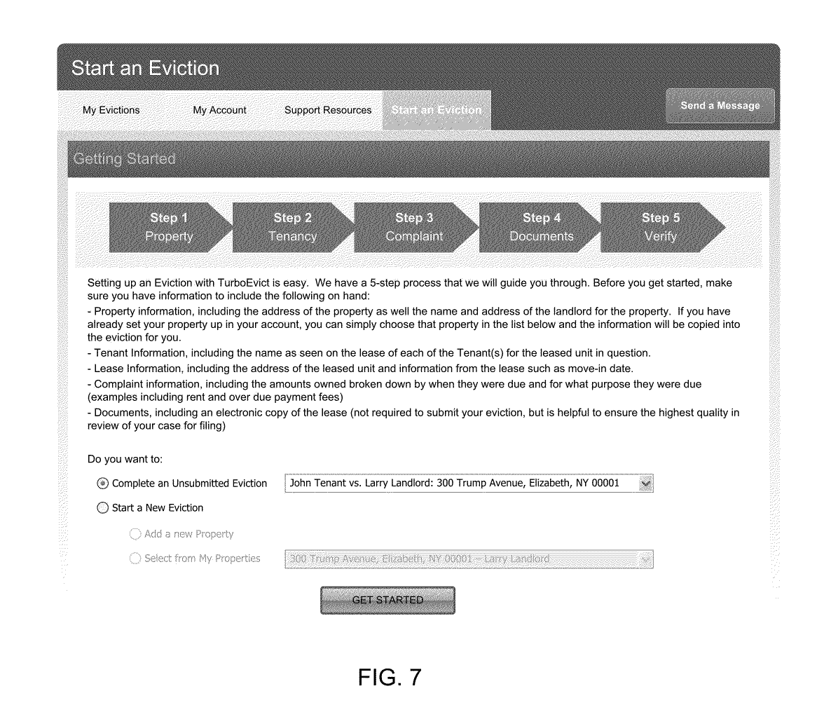

With reference to FIG. 7-12, system 100 guides a user through a series of steps, in the form of an intelligent guide, altering presented steps based on previously entered data. In FIG. 7, five steps are shown in a logical sequence for conducting a potential eviction, including entering information pertaining to: the subject property, the tenant, the complaint, supporting documents, and entering documents and data. System 100 presents one or more opportunities to provide information to the system, for example using text boxes, checkboxes, and radio buttons. Software executing within system 100 analyzes the data thus entered, and generates a series of tasks based on this data. The quantity and nature of tasks generated may depend in part upon a resolution of preceding tasks, as determined by software executing within system 100. Some tasks may be completed by system 100, for example generating documents, and other tasks are completed by people, who enter data into system 100 to indicate a status of the task.

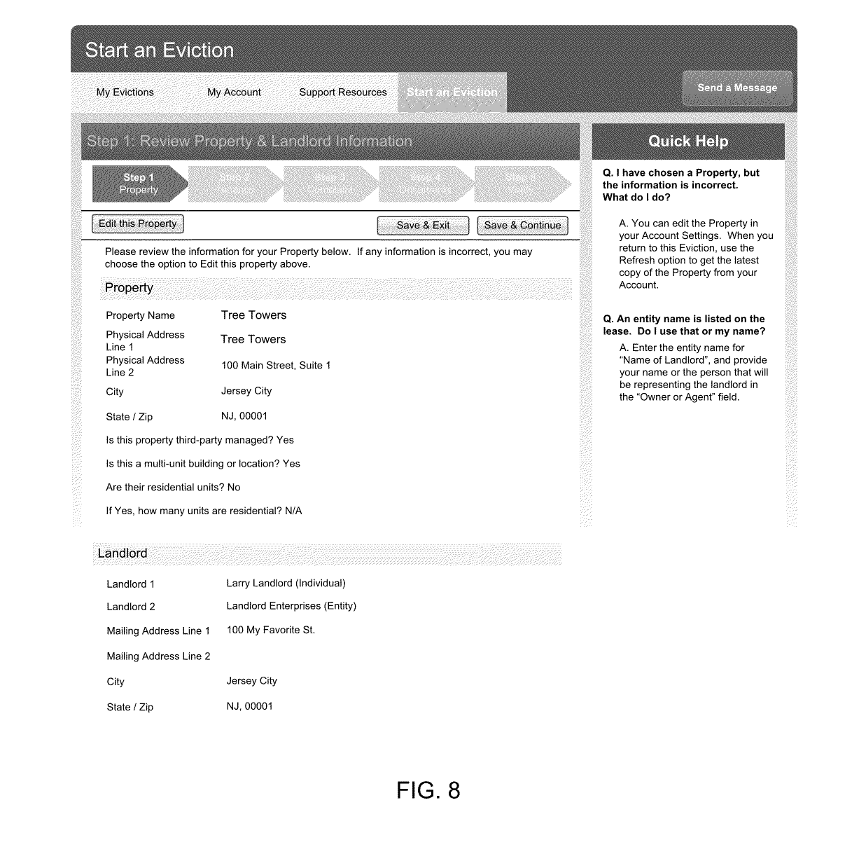

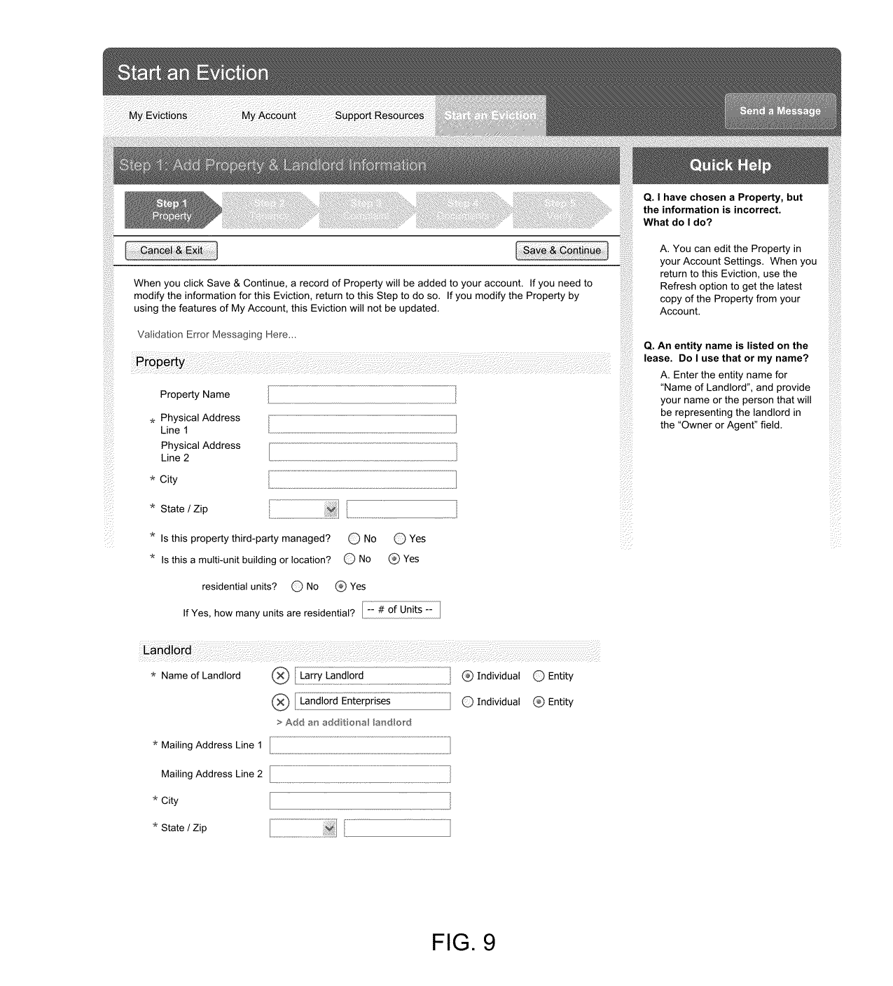

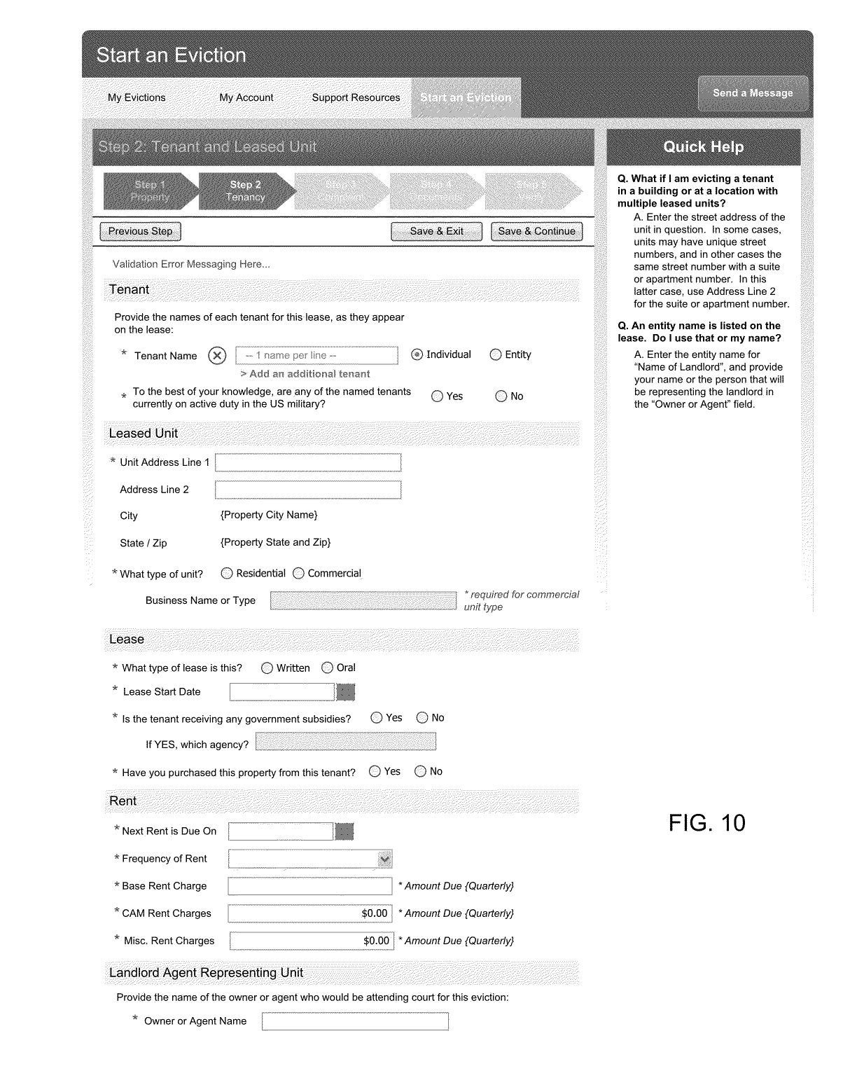

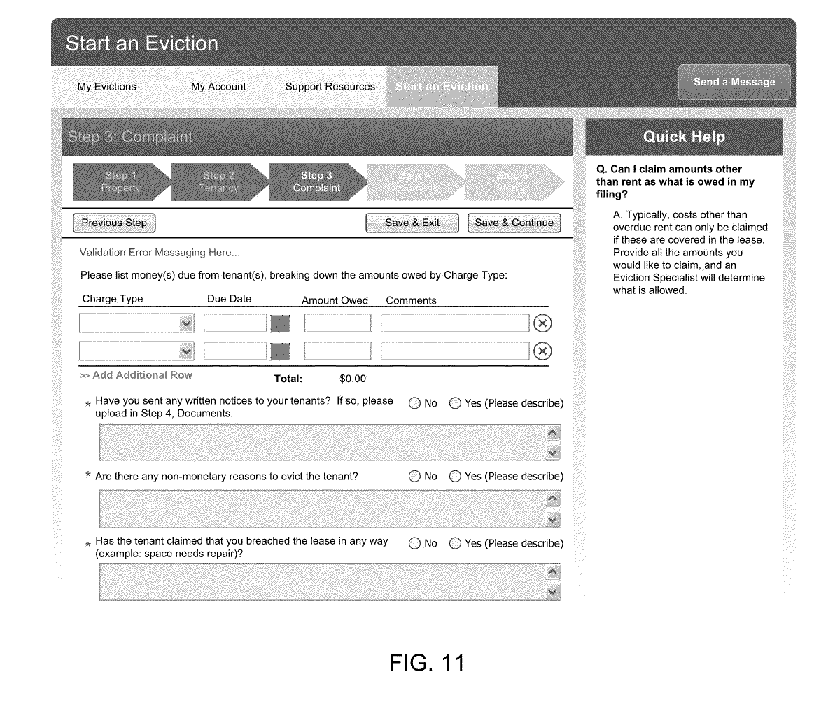

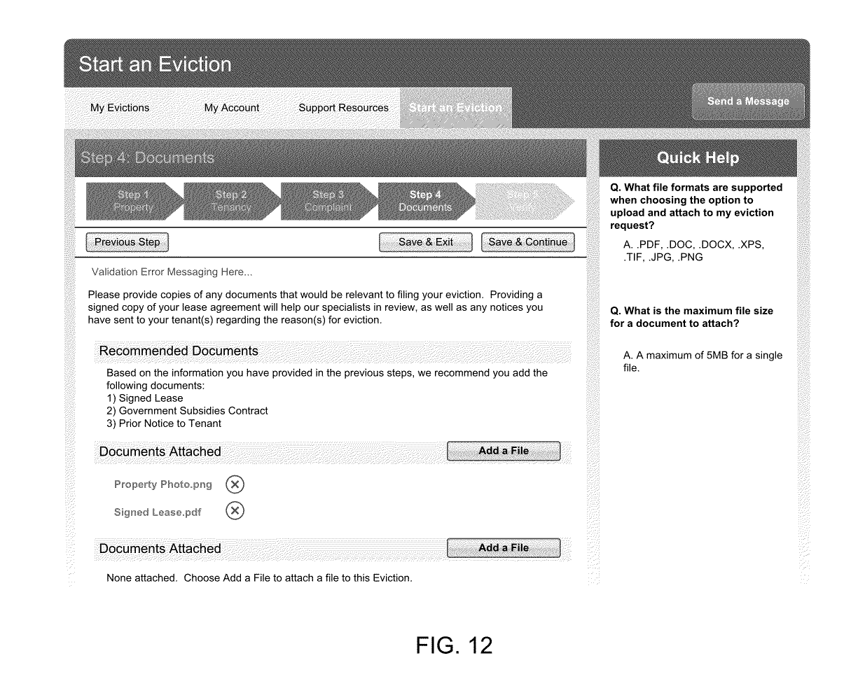

FIG. 8 illustrates a summary screen of data entered into system 100, and FIG. 9 illustrates a data entry form presented by system 100 for entering data into system 100. FIG. 10 illustrates at least a portion of Step 2, entering information pertaining to the tenancy. FIG. 11 illustrates at least a portion of Step 3, entering information pertaining to the complaint, or breach of the tenancy. FIG. 12 illustrates at least a portion of Step 4, including uploading of documents into system 100, whereupon the documents may be analyzed; completed; forwarded; and or interpreted by optical character recognition (OCR), whereupon data may be automatically entered into system 100

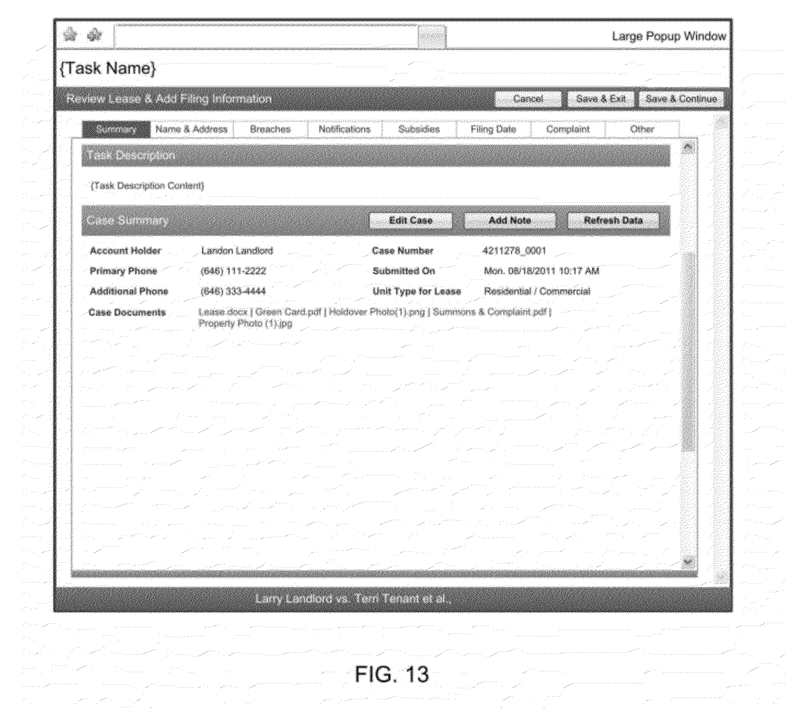

In each step, system 100 may provide opportunities to enter or view summary or detailed information pertaining to processing a breach. In the example of FIG. 13, a pop-up window presents data which may be useful to view in combination with completing a task. In addition to presenting data, changes may be made to the viewed data in real time, without leaving a currently active task.

System 100 thus enables a user to begin the process of conducting a potential eviction by gathering and entering appropriate information into system 100 immediately, without assistance of experts. The user is further conducted through the process of uploading the entirety of information expected to be required in order to process or prosecute the breach. In addition, while carrying out tasks assigned by system 100, a user may alter previously stored information, and use that stored information, without terminating data entry or processing of a current task.

System 100 further enables a user to answer factual questions pertaining to an eviction process without requiring the user to fully understand the legal process and documents required. Once the factual questions have been answered, system 100 then prepares a complex legal document incorporating the answers to the factual questions, which document meets all of the legal requirements of the applicable jurisdiction.

By automating much of the process for conducting an eviction using a computer system, system 100 enables an economically viable option of conducting such work at a flat fee. While certain evictions may involve more work than others, system 100 creates a more uniform process, generally. System 100 may further process payment for the use of system 100, and for paying attorneys and other service providers, who may or may not also use system 100. System 100 may further advantageously be used in combination with a flat fee for both monetary (e.g. unpaid rent) and non-monetary (e.g. nuisance) breaches, although system 100 engages in different task logic for each type of breach, to an extent.

By providing comprehensive summaries and detail screens, which may be saved to a variety of non-transitory media, system 100 transforms information from a wide variety of disparate sources, including data from the landlord, the tenant, attorneys, the courts, vendors, and system managers, into a seamless, easily understood, and logically integrated visual format. System 100 further associates information which was disparate prior to being entered into system 100. For example, selection of a property coordinates the presentation and use of information pertaining to the landlord of the property, or former eviction proceedings, for example. Such information may include any or all of: case archives, communications among all system 100 participants, documents, filings, and court dates. System 100 may present all details of an eviction case in one location.

In an embodiment, all pending evictions for a landlord may access and displayed, together with a status of these evictions, and a notification of any unviewed information or updates since a prior access of the information. System 100 may previously have provided email notifications, or other form of notification, of such unviewed information, and advantageously additionally provides a live status notification as changes to information occur.

While a number of tasks related to remedying a breach are carried out by people, it should be understood that system 100 generally creates a series of system tasks, assigns them to individual people at an appropriate time, tracks timeliness and due dates, executes remedial tasks when a task is overdue or incomplete, escalates tasks to people of greater responsibility, and communicates with people as needed to ensure tasks are carried out in a timely and effective manner.

For example, a task of “Enter Court Appearance” includes entering a date associated with the required appearance. System 100 uses the entered data to create the task “Enter Court Results”. This task is assigned to an appropriate person to ensure results are entered into system 100, which in turn triggers system 100 to create further tasks.

As additional specific examples, when engaged in an “Enter Court Results” task, system 100 prompts the user if Court was Adjourned. If the entered data was in the negative, system 100 dynamically changes the next series of questions to pertain to entering court results. In the example of a Default Judgment, system 100 will prompt for a confirmation of the amount owed to the landlord and expected data of requesting a warrant. System 100 will further generate the warrant to complete the task, spawning a subsequent task, “Print and Mail Request Warrant”.

Alternatively, if a user responds to the initial question regarding Court Adjournment in the affirmative, system 100 prompts “Was the new court date announced?”, thereby allowing a date to be entered, accommodating variations in scheduling by the court. Whether or not a date was announced, system 100 then sends a court card to the attorney assigned by system 100, and then proceeds to the next appropriate task. However, if a court date is not announced, system 100 once again queues a task for “Upload Court Card”, with a new due date selected based upon software executing within system 100, which may advantageously examine a plurality of factors to determine appropriate action and reminder dates. If a new court date has been announced, a subsequent task selected by system 100 is a return to the Enter Court Results task, which is due on the day of the new court appearance. System 100 further reminds participants of due dates, and also monitors potential scheduling conflicts of system 100 users and participants, and either resolves the conflict based upon software logic, or prompts a user for a resolution.

Accordingly, it may be seen that system 100 contains a substantial amount of logic embodying an in depth knowledge of the process of managing a breach, and conducting an a potential eviction, in particular, moving the eviction process forwards and backwards along a series of tasks based upon logic which includes the laws of the applicable jurisdiction. A workflow and series of tasks created by system 100 advantageously includes all possible known outcomes. System 100 further logs changes made within system 100, for diligence, and for tracking problems and improving performance. Security within system 100 governs which individuals can respond to a task, escalate a task, close out a task, and perform all significant actions using system 100.

It will be appreciated by persons skilled in the art that the present disclosure is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the disclosure.

All references cited herein are expressly incorporated by reference in their entirety. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

What is claimed is:

1. A method for facilitating corrective action by an owner with respect to a user of the owner's property who is in breach of an agreement with the owner, comprising using at least one computer server to:
receive, into storage connectable to the at least one computer server, information pertaining to the owner, the property, and the user;
receive, into storage connectable to the at least one computer server, documents and information, including date information, pertaining to a tribunal that has jurisdiction with respect to the breach;
receive, into storage connectable to the at least one computer server, messages between the owner and one or more service providers practicing before the tribunal;
communicate in real time, using the at least one server, said information received into storage, with the owner, and the one or more service providers; and
calculate a workflow, including a sequence of actions to be carried out, said sequence of actions based upon information with respect to the owner, the property, the user, and the tribunal, said workflow operative to guide the owner or the one or more service providers with respect to actions which resolve the breach.

2. The method of claim 1, further including communicating in real time said information received into storage, with an administrator of the method and the at least one computer server.

3. The method of claim 1, wherein said one or more server creates a log of communication among the owner and one or more service providers.

4. The method of claim 1, wherein the one or more server prompts the owner or the one or more service providers to generate a complaint using the one or more server, file the complaint with a court, record a receipt of complaint from the court, record information from the court pertaining to the complaint, and electronically communicate information from the court to the owner and the one or more service providers.

5. The method of claim 4, wherein the one or more server further prompts the owner or the one or more service providers to track a disposition of the court, and to track payments from a user if the court so orders.

6. The method of claim 1, wherein the breach relates to a lease, the owner is a landlord, and the user is a tenant.

7. The method of claim 1, wherein the breach relates to a lease, and the corrective action is an eviction of the user, who is a tenant.

8. The method of claim 1, wherein documents are received into storage connectable to the at least one computer server are scanned or generated by the one or more server.

9. The method of claim 1, wherein the service provider is a legal service provider or attorney.

10. The method of claim 1, further including, using the at least one computer server:
presenting a series of questions, generated by software executing upon the at least one computer server, to at least one of the owner, service provider, and user, the questions related to a specific task relating to the breach; and
analyzing responses to at least one of the series of questions, and determining subsequent questions based upon the analyzed responses, the owner, service provider, user, or at least one computer server thereby guided to produce information needed to accomplish the task.

11. The method of claim 10, wherein the series of questions include a question relating to an event selected from the group consisting of whether or not: the breach relates to a residential or commercial lease, the user appeared before the tribunal, the user cured the breach, a stipulation was agreed to, the case was heard by the tribunal, whether the breach is for payment or non-performance, and whether the breach is for holdover.

12. The method of claim 10, wherein the series of questions include a question relating to an event selected from the group consisting of whether or not: the tribunal rescheduled a hearing, the tribunal announced a new hearing date, the tribunal was adjourned, the court issued a judgment, the court issued a judgment for possession, and the court issued a warrant.

13. The method of claim 10, wherein the series of questions include a question relating to an event selected from the group consisting of: contract information, complaint information, and a desired legal course of direction; and further including
creating at least one task operative to further the desired legal course of direction.

14. The method of claim 1, wherein the series of questions are related to creating one or more documents useable for filing a new case with the tribunal.

15. The method of claim 1, further including, using the at least one computer server:
storing information pertaining to prior corrective actions of an owner, and the current status of at least one of the prior corrective actions; and
presenting, upon request of the owner, a detailed list of the stored information.

16. The method of claim 1, further including, using the at least one computer server:
storing information with respect to one or more corrective actions, the information including communications, the calculated workflow, documents relating to the workflow, and a status of the corrective actions;
organizing the stored information in a sequentially ordered format; and
presenting a detailed report of the organized information.

17. The method of claim 16, further including using the at least one computer server to determine possible upcoming events or tasks relating to the one or more corrective actions, and adding the possible upcoming events or tasks to the organized information.

18. The method of claim 1, wherein the documents received into storage connectable to the at least one computer server are scanned or generated by the one or more server.

19. A method for facilitating an action for eviction by a landlord with respect to a tenant who is in breach of a lease with the landlord, comprising using at least one computer server to:
receive, into storage connectable to the at least one computer server, information pertaining to the landlord, the real property, and the tenant;
receive, into storage connectable to the at least one computer server, documents and information, including date information, pertaining to a tribunal that has jurisdiction with respect to landlord tenant actions;
receive, into storage connectable to the at least one computer server, messages between the owner and one or more attorneys practicing before the tribunal;
communicate in real time, using the at least one server, said information received into storage, with the landlord, and the one or more attorneys; and
calculate a workflow, including a sequence of actions to be carried out, said sequence of actions based upon information with respect to the landlord, the real property, the tenant, and the tribunal, said workflow operative to guide the owner or the one or more attorneys with respect to actions which address the breach for the benefit of the landlord.

20. The method of claim 19, further including communicating in real time said information received into storage, with an administrator of the method and the at least one computer server.

21. The method of claim 19, wherein said one or more server creates a log of communication among the landlord and one or more attorneys.

22. The method of claim 19, wherein the one or more server prompts the landlord or the one or more attorneys to generate a complaint using the one or more server, file the complaint with a court, record a receipt of complaint from the court, record information from the court pertaining to the complaint, and communicate information from the court to the landlord and the one or more attorney.

23. The method of claim 22, wherein the one or more server further prompts the landlord or the one or more attorneys to track a disposition of the court, and to track payments from a tenant if the court so orders.

24. A system for facilitating an action for eviction by a landlord with respect to a tenant who is in breach of a lease with the landlord, comprising:
at least one computer server connected to non-transitory media including instructions operative to:
receive, into storage connectable to the at least one computer server, information pertaining to the landlord, the real property, and the tenant;
receive, into storage connectable to the at least one computer server, documents and information, including date information, pertaining to a tribunal that has jurisdiction with respect to landlord tenant actions, including information pertaining to case assignments, court appearances, court calendar, and court orders;
receive, into storage connectable to the at least one computer server, messages between the owner and one or more attorneys practicing before the tribunal;
communicate in real time, using the at least one server, said information received into storage, with the landlord, and the one or more attorneys; and
calculate a workflow, including a sequence of actions to be carried out, said sequence of actions based upon information with respect to the landlord, the real property, the tenant, and the tribunal, said workflow operative to guide the owner or the one or more attorneys with respect to actions which resolve the breach, and including the information received into storage connectable to the at least one computer server, communications to the tenant, communications to the court, tracking responses from the tenant, and tracking responses from the court.
